(19) United States
(12) Patent Application Publication
(10) Pub. No.: US 2024/0373485 A1
(43) Pub. Date: Nov. 7, 2024

(54) COMMUNICATION CONTROL METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 18/778,218

(22) Filed: Jul. 19, 2024

Related U.S. Application Data
(63) Continuation of application No. PCT/JP2023/001568, filed on Jan. 19, 2023.
(60) Provisional application No. 63/301,783, filed on Jan. 21, 2022.

(51) Int. Cl. H04W 76/14; H04L 5/00; H04W 76/15; H04W 76/20; H04W 92/18

(52) U.S. Cl. CPC H04W 76/14; H04L 5/0053; H04W 76/15; H04W 76/20; H04W 92/18

(57) ABSTRACT

A communication control method is a communication control method in a mobile communication system configured to perform a first communication on a direct link between a first remote user equipment and a second remote user equipment, and a second communication on an indirect link between the first remote user equipment and the second remote user equipment via a relay user equipment. The communication control method includes transmitting, by the first remote user equipment having established the direct link with the second remote user equipment, a multi-link split bearer establishment request message to the second remote user equipment via the direct link, the multi-link split bearer establishment request message including identification information of the relay user equipment.

### RELATED APPLICATIONS

The present application is a continuation based on PCT Application No. PCT/JP2023/001568, filed on Jan. 19, 2023, which claims the benefit of U.S. Provisional Patent Application No. 63/301,783 filed on Jan. 21, 2022. The content of which is incorporated by reference herein in their entirety.

### TECHNICAL FIELD

The present disclosure relates to a communication control method used in a mobile communication system.

### BACKGROUND

For a mobile communication system based on the 3rd Generation Partnership Project (3GPP) standard, a technology of sidelink relay using a user equipment as a relay node has been under study (e.g., see “3GPP TS 38.300 V16.8.0 (2021-12)”). The sidelink relay is a technology in which a relay node referred to as a relay user equipment (Relay UE) mediates communication between a base station and a remote user equipment (Remote UE) and relays the communication.

### SUMMARY

In a first aspect, a communication control method is a communication control method in a mobile communication system configured to perform a first communication on a direct link between a first remote user equipment and a second remote user equipment, and a second communication on an indirect link between the first remote user equipment and the second remote user equipment via a relay user equipment. The communication control method includes transmitting, by the first remote user equipment having established the direct link with the second remote user equipment, a multi-link split bearer establishment request message to the second remote user equipment via the direct link, the multi-link split bearer establishment request message including identification information of the relay user equipment. The communication control method includes transmitting, by the second remote user equipment, a multi-link split bearer establishment acknowledgement message to the first remote user equipment via the direct link after establishing a connection to the relay user equipment, the multi-link split bearer establishment acknowledgement message including the identification information. Further, the communication control method includes establishing, by the first remote user equipment, a connection to the relay user equipment.

In a second aspect, a communication control method is a communication control method in a mobile communication system configured to perform a first communication on a direct link between a first remote user equipment and a second remote user equipment, and a second communication on an indirect link between the first remote user equipment and the second remote user equipment via a relay user equipment. The communication control method includes transmitting, by the first remote user equipment having established the direct link, a first multi-link split bearer establishment request message to the relay user equipment, the first multi-link split bearer establishment request message including identification information of the second remote user equipment and identification information of a sidelink data bearer. The communication control method includes transmitting, by the relay user equipment, a second multi-link split bearer establishment request message to the second remote user equipment, the second multi-link split bearer establishment request message including the identification information of the sidelink data bearer. Further, the communication control method includes establishing, by the second remote user equipment and the relay user equipment, the indirect link.

In a third aspect, a communication control method is a communication control method in a mobile communication system configured to perform a first communication on a direct link between a first remote user equipment and a second remote user equipment, and a second communication on an indirect link between the first remote user equipment and the second remote user equipment via a relay user equipment. The communication control method includes transmitting, by the first remote user equipment having established the direct link, a first discovery message including first identification information of the first remote user equipment and second identification information of the second remote user equipment. The communication control method includes transmitting, by the relay user equipment, a second discovery message including the first identification information and the second identification information in response to receiving the first discovery message. Further, the communication control method includes selecting, by the second remote user equipment, the relay user equipment as a suitable relay user equipment based on the second discovery message. Further, the communication control method includes establishing, by the second remote user equipment and the relay user equipment, the indirect link.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a UE according to the first embodiment.

FIG. 3 is a diagram illustrating a configuration example of a gNB according to the first embodiment.

FIG. 4 is a diagram illustrating a configuration example of a protocol stack of a user plane according to the first embodiment.

FIG. 5 is a diagram illustrating a configuration example of a protocol stack of a control plane according to the first embodiment.

FIG. 6 is a diagram illustrating an assumed scenario according to the first embodiment.

FIG. 7 is a diagram illustrating a configuration example of a protocol stack of a user plane in the assumed scenario according to the first embodiment.

FIG. 8 is a diagram illustrating a configuration example of a protocol stack of a control plane in the assumed scenario according to the first embodiment.

FIG. 9 is a diagram illustrating a configuration example of a mobile communication system for the first embodiment.

FIG. 10 is a diagram illustrating an operation example for the first embodiment.

FIG. 11 is a diagram illustrating an operation example according to a second embodiment.

FIG. 12 is a diagram illustrating an operation example according to a variation of the second embodiment.

### DESCRIPTION OF EMBODIMENTS

A mobile communication system according to an embodiment is described with reference to the drawings. In the description of the drawings, the same or similar parts are denoted by the same or similar reference signs.

### Configuration Example of Mobile Communication System

In an embodiment, a configuration example of a mobile communication system is described. In the embodiment, a mobile communication system 1 is a 3GPP 5G system. Specifically, a radio access scheme in the mobile communication system 1 is New Radio (NR) being a radio access scheme of the 5G. Note that Long Term Evolution (LTE) may be at least partially applied to the mobile communication system 1. Future mobile communication systems such as the 6G may be applied to the mobile communication system 1.

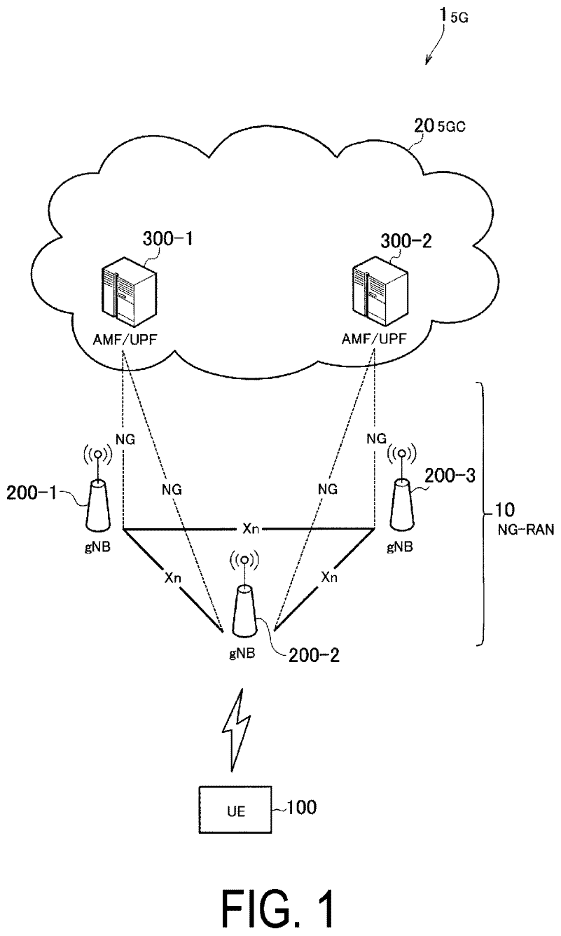

FIG. 1 is a diagram illustrating a configuration example of the mobile communication system 1 according to an embodiment.

As illustrated in FIG. 1, the mobile communication system 1 includes a User Equipment (UE) 100, a 5G radio access network (Next Generation Radio Access Network (NG-RAN)) 10, and a 5G Core Network (5GC) 20.

The UE 100 is a mobile wireless communication apparatus. The UE 100 may be any apparatus as long as the UE 100 is used by a user. Examples of the UE 100 include a mobile phone terminal (including a smartphone) or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency. Note that, hereinafter, the “cell” and the base station may be used without distinction.

Note that the gNB 200 can be connected to an Evolved Packet Core (EPC) corresponding to a core network of LTE. An LTE base station can also be connected to the 5GC 20. The LTE base station and the gNB 200 can be connected to each other via an inter-base station interface.

The 5GC 20 includes an Access and Mobility Management Function (AMF) and a

User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF 300 are connected to the gNB 200 via an NG interface which is an interface between the base station and the core network.

### Configuration of User Equipment

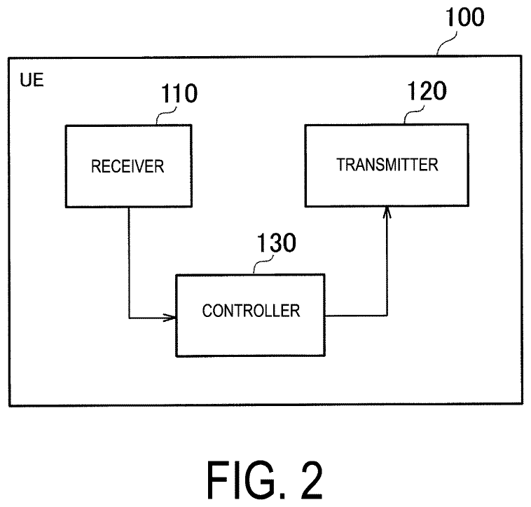

In the embodiment, a configuration example of the UE 100 that is a user equipment is described. FIG. 2 is a diagram illustrating the configuration example of the UE 100.

As illustrated in FIG. 2, the UE 100 includes a receiver 110, a transmitter 120, and a controller 130.

The receiver 110 performs various types of reception under control of the controller 130. The receiver 110 includes an antenna and converts (down-converts) a radio signal received by the antenna into a baseband signal (reception signal) which is then output to the controller 130.

The transmitter 120 performs various types of transmission under control of the controller 130. The transmitter 120 includes an antenna and converts (up-converts) the baseband signal (transmission signal) output by the controller 130 into a radio signal which is then transmitted from the antenna.

The controller 130 performs various types of control in the UE 100. The controller 130 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. Note that the controller 130 may perform respective processing operations and/or respective operations in the UE 100 in each embodiment described below.

### Configuration Example of Base Station

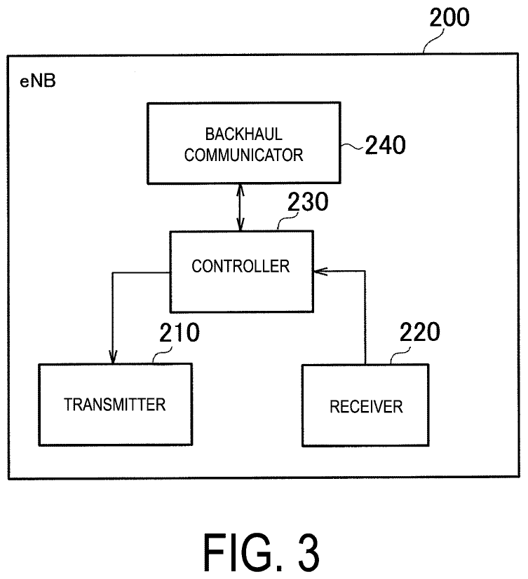

In the embodiment, a configuration example of the gNB 200 that is a base station is described. FIG. 3 is a diagram illustrating a configuration example of the gNB 200.

As illustrated in FIG. 3, the gNB 200 includes a transmitter 210, a receiver 220, a controller 230, and a backhaul communicator 240.

The transmitter 210 performs various types of transmission under control of the controller 230. The transmitter 210 includes an antenna and converts (up-converts) a baseband signal (transmission signal) output by the controller 230 into a radio signal which is then transmitted from the antenna.

The receiver 220 performs various types of reception under control of the controller 230. The receiver 220 includes an antenna and converts (down-converts) a radio signal received by the antenna into a baseband signal (reception signal) which is then output to the controller 230.

The controller 230 performs various types of controls for the gNB 200. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. Note that, the controller 230 may perform respective processing operations and/or respective operations in the gNB 200 in each embodiment described below.

The backhaul communicator 240 is connected to a neighboring base station via the Xn interface. The backhaul communicator 240 is connected to the AMF and UPF 300 via the NG interface. Note that the gNB 200 may include a Central Unit (CU) and a Distributed Unit (DU) (i.e., functions are divided), and both units may be connected via an F1 interface. Configuration Example of Protocol Stack

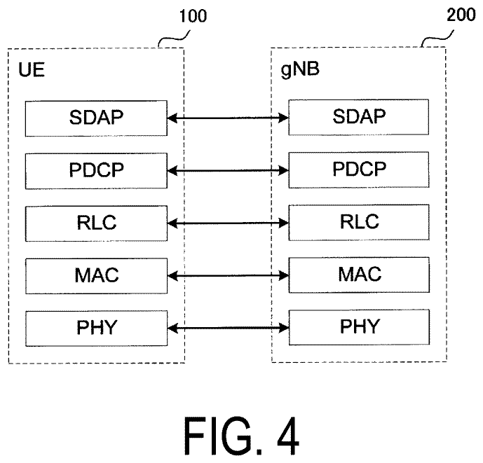

FIG. 4 is a diagram illustrating a configuration example of a protocol stack of a radio interface of a user plane handling data.

As illustrated in FIG. 4, a radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer. Note that, in the following, a layer and an entity may be used without distinction.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression and decompression, and encryption and decryption.

The SDAP layer performs mapping between an IP flow as the unit of Quality of Service (QOS) control performed by a core network and a radio bearer as the unit of QoS control performed by an AS (access stratum). Note that, when the RAN is connected to the EPC, the SDAP need not be provided.

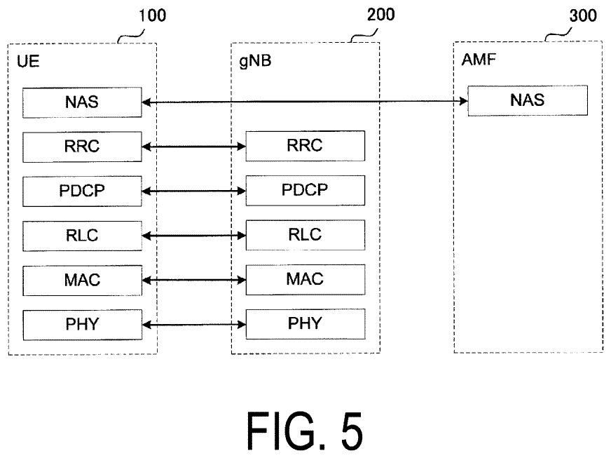

FIG. 5 is a diagram illustrating a configuration of a protocol stack of a radio interface of a control plane handling signaling (a control signal).

As illustrated in FIG. 5, the protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 exists, the UE 100 is in an RRC connected state. When no connection (RRC connection) between the RRC of the UE 100 and the RRC of the gNB 200 exists, the UE 100 is in an RRC idle state. When the RRC connection is suspended, the UE 100 is in an RRC inactive state.

The NAS layer which is positioned upper than the RRC layer performs session management, mobility management, and the like. NAS signaling is transmitted between the NAS layer of the UE 100 and the NAS layer of the AMF 300.

Note that the UE 100 includes an application layer other than the protocol of the radio interface.

### First Embodiment

A first embodiment is described.

### Assumed Scenario

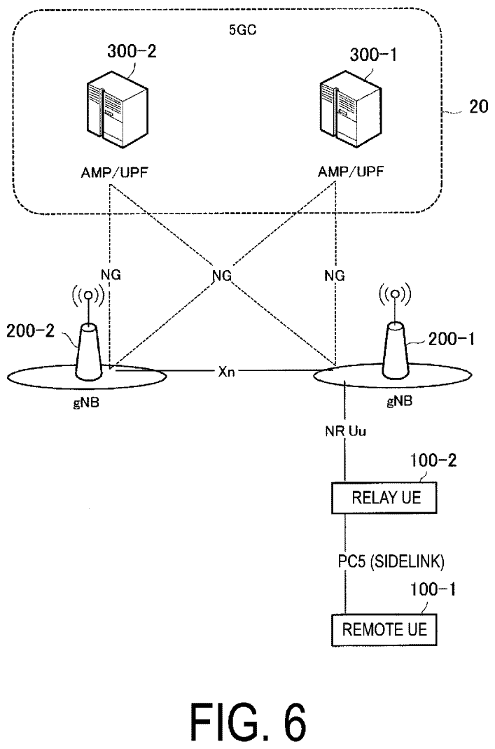

According to the first embodiment, an assumed scenario for the mobile communication system 1 is described. FIG. 6 is a diagram illustrating the assumed scenario.

As illustrated in FIG. 6, a scenario is assumed that uses a sidelink relay in which a relay UE 100-2 mediates a communication between the gNB 200-1 and a remote UE 100-1 and relays the communication. In other words, in the scenario, the gNB 200-1 and the remote UE 100-1 communicate via the relay UE 100-2.

The remote UE 100-1 performs wireless communication (sidelink communication) with the relay UE 100-2 on a PC5 interface (sidelink) used as an inter-UE interface. The relay UE 100-2 performs wireless communication (Uu communication) with the gNB 200-1 on an NR Uu interface. As a result, the remote UE 100-1 indirectly communicates with the gNB 200-1 via the relay UE 100-2. The Uu communication includes uplink communication and downlink communication.

### Configuration Example of Protocol Stack in Assumed Scenario

A configuration example of a protocol stack in the assumed scenario is described.

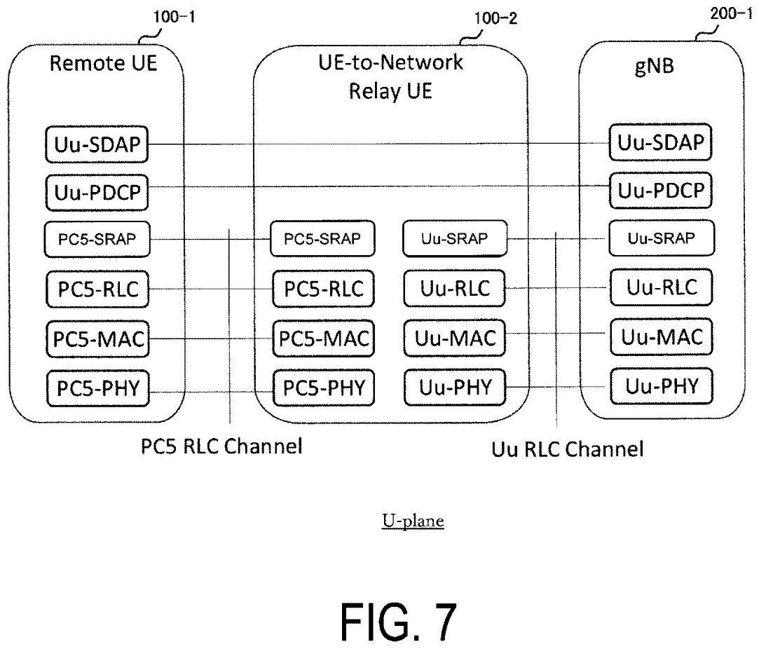

FIG. 7 is a diagram illustrating an example of a protocol stack of a user plane in the assumed scenario. FIG. 7 is also an example of a protocol stack of a user plane in relay via the relay UE 100-2 (i.e., U2N (UE to Network) relay).

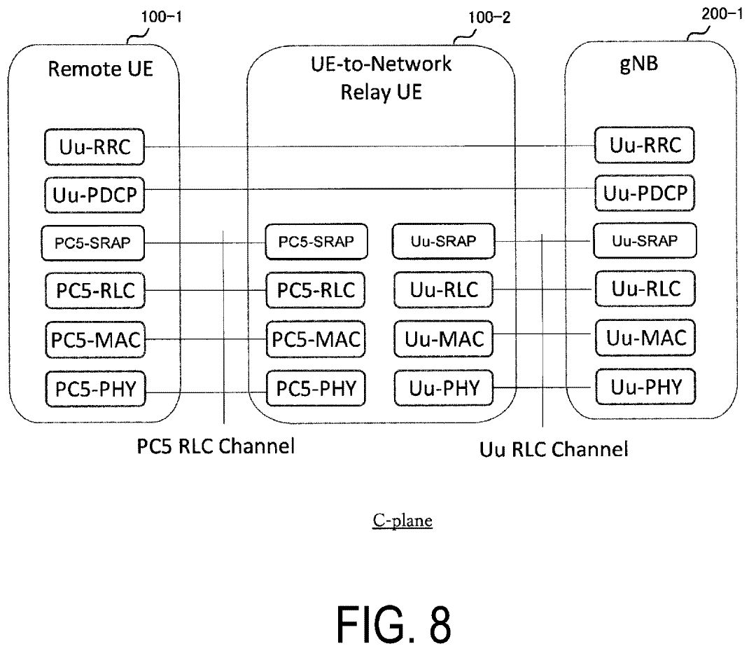

FIG. 8 is a diagram illustrating an example of a protocol stack of a control plane in the assumed scenario. FIG. 8 is also an example of a protocol stack of a control plane in the U2N relay.

As illustrated in FIG. 7, the gNB 200-1 includes a Uu-SRAP (sidelink relay adaptation protocol) layer, a Uu-RLC layer, a Uu-MAC layer, and a Uu-PHY layer which are used for communication on the NR Uu interface (Uu communication).

The relay UE 100-2 includes a Uu-SRAP layer, a Uu-RLC layer, a Uu-MAC layer, and a Uu-PHY layer which are used for communication on the NR Uu interface (Uu communication). The relay UE 100-2 includes a PC5-SRAP layer, a PC5-RLC layer, a PC5-MAC layer (PC5), and a PC5-PHY layer which are used for communication on the PC5 interface (PC5 communication).

The remote UE 100-1 includes a Uu-SDAP layer and a Uu-PDCP layer which are used for communication on a Uu interface (Uu). The remote UE 100-1 includes a PC5-SRAP layer, a PC5-RLC layer, a PC5-MAC layer (PC5), and a PC5-PHY layer which are used for communication on the PC5 interface (PC5 communication).

As illustrated in FIG. 8, in the control plane, a Uu-RRC layer is disposed instead of the Uu-SDAP layer of the user plane.

As illustrated in FIGS. 7 and 8, the SRAP layers are disposed on the Uu interface and the PC5 interface. Each SRAP layer is an example of a so-called adaptation layer. The SRAP layer is present only in a layer 2 relay and does not exist in a layer 3 relay. The SRAP layer is present in all of the remote UE 100-1, the relay UE 100-2, and the gNB 200-1. Further, the SRAP layer includes two layers of PC5-SRAP and Uu-SRAP. The PC5-SRAP and the Uu-SRAP each have a bearer mapping function. For example, the bearer mapping function is as follows. In other words, the remote UE 100-1 and the Uu-SRAP of gNB 200-1 perform mapping between the bearer (Uu-PDCP) and the PC5 RLC channel (PC5-RLC). The PC5-SRAP and the Uu-SRAP of the relay UE 100-2 perform mapping between the PC5 RLC channel (PC5-RLC) and the Uu RLC channel (Uu-RLC). Further, the Uu-SRAP has an identification function of the remote UE 100-1.

Note that, although not illustrated in FIGS. 7 and 8, each of the remote UE 100-1 and the relay UE 100-2 may include an RRC layer for PC5. Such an RRC layer is referred to as a “PC5-RRC layer”. The PC5-RRC connection and the PC5 unicast link between the remote 100-1 and the UE 100-2 are in a one-to-one correspondence, and the PC5-RRC connection is established after the PC5 unicast link is established.

Although not illustrated in FIGS. 7 and 8, each of the remote UE 100-1 and the relay UE 100-2 may include a PC5-S (signaling) protocol layer. The PC5-S protocol layer is an upper layer of the PDCP layer. Like the PC5-RRC layer, the PC5-S protocol layer is also a layer for transmission of control information.

### Communication Control Method According to First Embodiment

In the 3GPP, a multi-path UE to Network (U2N) sidelink relay may be discussed. The multi-path U2N sidelink relay refers to a relay in which one path is a Direct link (in other words, Uu) and another path is an indirect link (in other words, a U2N sidelink relay). The Direct link is a link between a network (e.g., gNB) and the remote UE 100-1 without involving the relay UE 100-2. The Indirect link is a link between the network and the remote UE 100-1 via the relay UE 100-2.

Meanwhile, the 3GPP defines a split bearer. The split bearer includes a split bearer by Dual Connectivity (DC) and a split bearer by Multicast and Broadcast Service (MBS). When the split bearer by the DC is configured, the PDCP entity is associated with the RLC entity of the Master Cell Group (MCG) and the RLC entity of the Secondary Cell Group (SCG). When the split bearer by the MBS is configured, the PDCP entity is associated with the RLC entity for Point-to-Multipoint (PTM) and the RLC entity for PTP (point-to-point). In either of the split bearers, the PDCP entity is an anchor point associating two divided RLC entities with each other.

Considering the multi-path U2N sidelink relay and the split bearer, a “multi-link split bearer” is also conceivable. A “multi-link split bearer” is, for example, a split bearer including a direct link and an indirect link.

In the 3GPP, priorities are defined between a UL transmission (direct link) and a sidelink relay (indirect link). Therefore, for example, it is not assumed that the remote UE 100-1 performs a UL transmission and a sidelink relay at the same time.

However, the “multi-link split bearer” allows the remote UE 100-1 to transmit the same data using the two links or transmit different data using the two links. The “multi-link split bearer” also allows the remote UE 100-1 to use one link as for a control plane (CP) and use another link as for a user plane (UP).

In this way, various implementations can be supported by the “multi-link split bearer”.

The “multi-link split bearer” is applicable to various forms of sidelink relay.

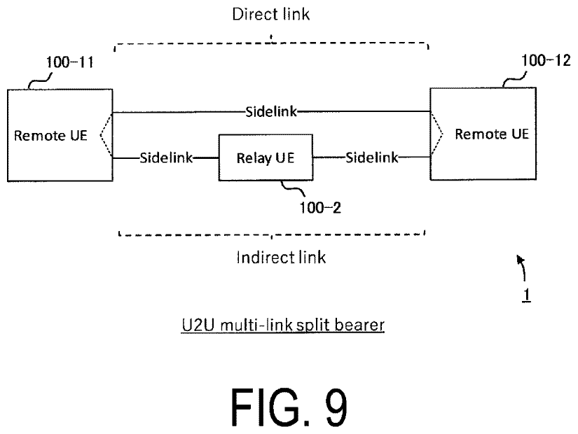

FIG. 9 illustrates a configuration example of the mobile communication system 1 when the “multi-link split bearer” is applied to a UE to UE (U2U) sidelink relay. Such a “multi-link split bearer” is referred to as a “U2U multi-link split bearer”.

As illustrated in FIG. 9, a Direct link (PC5) is configured between a first remote UE 100-11 and a second remote UE 100-12. An indirect link (PC5) is configured between the first remote UE 100-11 and the second remote UE 100-12 via the relay UE 100-2. The “U2U multi-link split bearer” is configured by the direct link and the indirect link.

Specifically, the mobile communication system 1 illustrated in FIG. 9 is capable of performing a first communication on a direct link between a first remote user equipment (e.g., first remote UE 100-11) and a second remote user equipment (e.g., second remote UE 100-12), and a second communication on an indirect link between the first remote user equipment and the second remote user equipment via a relay user equipment (e.g., relay UE 100-2).

In this way, the “U2U multi-link split bearer” being configured allows, for example, the first remote UE 100-11 to transmit the same data to the second remote UE 100-12 via two links, or transmit different data with the second remote UE 100-12 via two links. This can improve the reliability of communication in the mobile communication system 1.

Here, a question is who configures the “U2U multi-link split bearer”. For such a question, the following options can be considered.

(1) The gNB (or pre-configured) performs configuration for the first remote UE 100-11 and the second remote UE 100-12 (and the relay UE 100-2).

(2) The first remote UE 100-11 performs configuration for the second remote UE 100-12 (and the relay UE 100-2).

The first embodiment describes the above option (2). The “U2U multi-link split bearer” is configured as a result of a negotiation between the first remote UE 100-11 and the second remote UE 100-12. The first embodiment describes the negotiation directly performed between the first remote UE 100-11 and the second remote UE 100-12.

To be specific, first, a first remote user equipment (e.g., first remote UE 100-11) transmits a multi-link split bearer establishment request message to a second remote user equipment (e.g., second remote UE 100-12) via a direct link, the multi-link split bearer establishment request message including identification information of a relay user equipment (e.g., relay UE 100-2). Second, the second remote user equipment transmits a multi-link split bearer establishment acknowledgement message to the first remote user equipment via the direct link after establishing a connection (e.g., PC5-RRC connection) to the relay user equipment, the multi-link split bearer establishment acknowledgement message including the identification information of the relay user equipment. Third, the first remote user equipment establishes a connection (e.g., PC5-RRC connection) to the relay user equipment.

In this way, the second remote UE 100-12 establishing the direct link with the first remote UE 100-11 can establish the PC5-RRC connection to the relay UE 100-2, based on the identification information included in the multi-link split bearer establishment request message. The first remote UE 100-11 can establish the PC5-RRC connection to the relay UE 100-2, based on the identification information included in the multi-link split bearer establishment acknowledgement message. This causes, for example, an indirect link to be established to allow the “U2U multi-link split bearer” to be configured in coordination with the direct link that has already been established.

### Operation Example According to First Embodiment

An operation example in the first embodiment will be described.

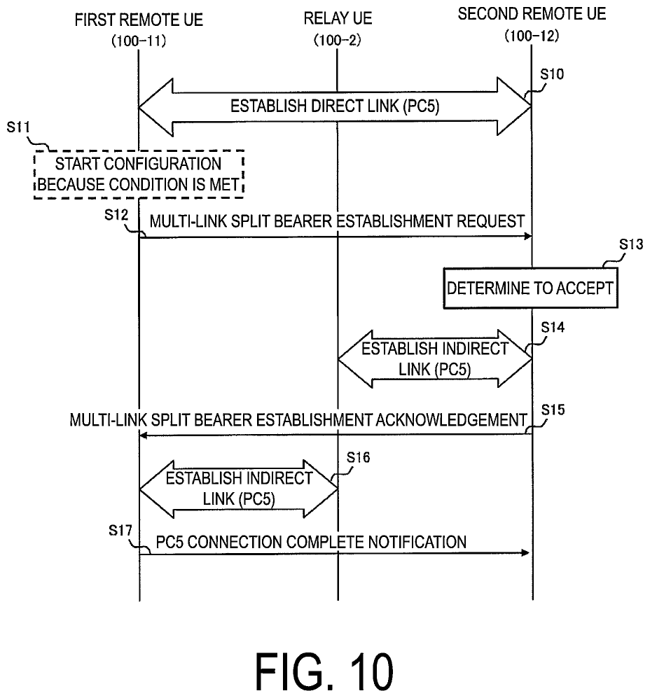

FIG. 10 is a diagram illustrating an operation example according to the first embodiment.

As illustrated in FIG. 10, in step S10, the first remote UE 100-11 establishes the direct link (PC5) with the second remote UE 100-12.

In step S11, the first remote UE 100-11 may be configured with a threshold and may start configuring the multi-link split bearer when a condition with the threshold is met. The threshold may be a Sidelink Reference Signal Received Power (SL-RSRP) or a Sidelink Discovery Reference Signal Received Power (SD-RSRP). The condition in this case is that a measurement value deteriorates worse than the threshold. Here, the case that the measurement value deteriorates may be a case that the measurement value (SL-RSRP, SD-RSRP, or the like) is lower than the threshold. The case that the measurement value deteriorates may be a case that the measurement value (BER, BLER, and/or PER) is higher than the threshold (a threshold corresponding to BER, BLER, and/or PER which is the measurement value). In other words, the first remote UE 100-11 starts the configuration (in other words, transmits the multi-link split bearer establishment request message in a subsequent stage) when (the measurement value representing) the radio condition for the second remote UE 100-12 deteriorates worse than the threshold. The threshold may be a communication quality threshold. The condition in this case is that a throughput or a delay deteriorates worse than the communication quality threshold. In other words, the first remote UE 100-11 starts the configuration when the throughput or the delay for the second remote UE 100-12 deteriorates worse than the communication quality threshold.

In step S12, the first remote UE 100-11 transmits a multi-link split bearer

establishment request message to the second remote UE 100-12 via the direct link. The message may be a RRCReconfigurationSidelink message. The message includes identification information of a relay UE that is a candidate (or intended by the first remote UE 100-11). That relay UE may be referred to as a “candidate relay UE”. The message may include a radio measurement result of the candidate relay UE. The message may include information requesting the multi-link split bearer establishment. The message may include identification information of a sidelink data bearer (Sidelink-Data Radio Bearer (SL-DRB)). The SL-DRB is a DRB for which a split bearer is to be configured.

In step S13, the second remote UE 100-12 determines to accept the multi-link split bearer establishment request. In other words, the second remote UE 100-12 determines to establish the “U2U multi-link split bearer” with the first remote UE 100-11. The second remote UE 100-12 may determine to accept the request, based on the radio measurement result included in the multi-link split bearer establishment request message.

In step S14, the second remote UE 100-12 selects a suitable relay UE from among the candidate relay UEs and establishes a PC5-RRC connection to the relay UE. For example, the second remote UE 100-12 measures radio qualities of the candidate relay UEs and considers the information included in the multi-link split bearer establishment request message to select a suitable relay UE from a plurality of candidate relay UEs. Here, a description is given below assuming that the relay UE 100-2 is selected as the suitable relay UE. The second remote UE 100-12 establishes the PC5-RRC connection to the relay UE 100-2. The second remote UE 100-12 may establish the PC5-RRC connection by transmitting an RRCReconfigurationSidelink message to the relay UE 100-2.

In step S15, the second remote UE 100-12 transmits a multi-link split bearer establishment acknowledgement message to the first remote UE 100-11 via the direct link after establishing the PC5-RRC connection to the relay UE 100-2. The multi-link split bearer establishment acknowledgement message is an acknowledgement message in response to the multi-link split bearer establishment request message in step S12 when the second remote UE 100-12 establishes the PC5-RRC connection to the relay UE 100-2. The multi-link split bearer establishment acknowledgement message may be an RRCReconfigurationCompleteSidelink message. The acknowledgement message includes the identification information (UEID, L2 ID, or L2 Destination ID) of the relay UE 100-2 to which the PC5-RRC connection has been established. Note that when the second remote UE 100-12 fails in the PC5-RRC connection to the relay UE 100-2, the second remote UE 100-12 may transmit a multi-link split bearer establishment negative acknowledgement message to the first remote UE 100-11 instead of the multi-link split bearer establishment acknowledgement message. The negative acknowledgement message may be an RRCReconfigurationFailureSidelink message.

In step S16, the first remote UE 100-11 establishes a PC5-RRC connection to the relay UE 100-2. Since the identification information of the relay UE 100-2 is included in the split bearer establishment acknowledgement message, the first remote UE 100-11 establishes the PC5-RRC connection to the relay UE 100-2 having the identification information. The first remote UE 100-11 may establish the PC5-RRC connection by transmitting an RRCReconfigurationSidelink message to the relay UE 100-2. As described above, an indirect link (PC5) via the relay UE 100-2 is established between the first remote UE 100-11 and the second remote UE 100-12.

In step S17, the first remote UE 100-11, after establishing the PC5-RRC connection to the relay UE 100-2, transmits a PC5-RRC connection complete notification message to the second remote UE 100-12 via the direct link. The second remote UE 100-12 may recognize that the first remote UE 100-11 has connected to the relay UE 100-2 by the PC5-RRC connection through the notification message and may recognize that the indirect link has been established.

The first remote UE 100-11 and the second remote UE 100-12 may configure a split bearer (i.e., “U2U multi-link split bearer”) by means of the direct link and the indirect link using identification information (UEID, L2 ID, L2 Destination ID, or the like) of the destination UE and the relay UE 100-2, identification information of the SL-DRB, and the like. For example, the split bearer is configured as follows. In other words, the second remote UE 100-12 establishes the direct link with the first remote UE 100-11 in step S10 (step S10), and confirms the SL-DRB which is a target of a split bearer in accordance with the identification information of the SL-DRB included in the multi-link split bearer establishment request message (step S12). The second remote UE 100-12 confirms the first remote UE 100-11 and the relay UE 100-2 which are targets of the split bearer in accordance with the identification information of the destination UE and the relay UE 100-2. The second remote UE 100-12, when establishing an indirect link with the relay UE 100-2 (step S14), associates the SL-DRB with an RLC channel related to the indirect link, a logical channel related to the indirect link, or the like. This configures a split bearer in the second remote UE 100-12. A split bearer is also configured in the first remote UE 100-11 in the same and/or similar manner. To this end, the multi-link split bearer establishment acknowledgement message (step S15) may include the identification information of the destination UE and the relay UE 100-2 which are the targets of the split bearer, and an RLC channel ID and a Logical Channel ID (LCID) which are the targets of the split bearer. The first remote UE 100-11, using this information, can configure a split bearer in the same and/or similar manner as the second remote UE 100-12. For configuring the split bearer, (identification information of) Signaling Radio Bearer (SL-SRB) may be used instead of (the identification information of) the SL-DRB.

The first remote UE 100-11 and the second remote UE 100-12 perform data transmission and reception via the direct link and/or the indirect link.

### Second Embodiment

A second embodiment is described.

The first embodiment has described the example in which the negotiation between the first remote UE 100-11 and the second remote UE 100-12 is directly performed between the first remote UE 100-11 and the second remote UE 100-12. The second embodiment describes a negotiation indirectly performed between the first remote UE 100-11 and the second remote UE 100-12 via the relay UE 100-2. The negotiation being indirectly performed also allows the “U2U multi-link split bearer” to be established.

To be specific, first, a first remote user equipment (e.g., first remote UE 100-11) having established a direct link with a second remote user equipment (e.g., second remote UE 100-12) transmits a first multi-link split bearer establishment request message to a relay user equipment (e.g., relay UE 100-2), the first multi-link split bearer establishment request message including identification information of the second remote user equipment and identification information of a sidelink data bearer. Second, the relay user equipment transmits a second multi-link split bearer establishment request message to the remote user equipment, the second multi-link split bearer establishment request message including the identification information of the sidelink data bearer. Third, the second remote user equipment and the relay user equipment establish an indirect link.

In this way, for example, the second remote UE 100-12 establishing the direct link with the first remote UE 100-11 can establish the PC5-RRC connection to the relay UE 100-2 in response to receiving the second multi-link split bearer establishment request message. The relay UE 100-2 can also establish the PC5-RRC connection to the first remote UE 100-11 in response to receiving the first multi-link split bearer establishment request message. Then, in the mobile communication system 1, for example, the “U2U multi-link split bearer” can be configured by using the identification information of the sidelink data bearer.

### Operation Example According to Second Embodiment

An operation example according to the second embodiment will be described.

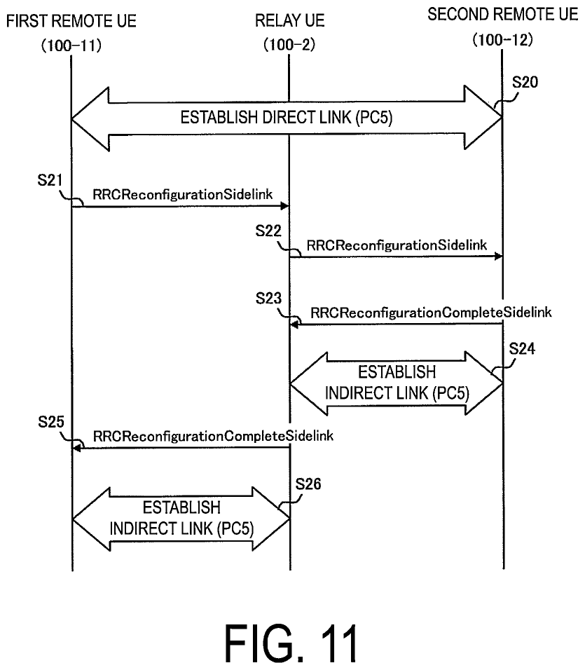

FIG. 11 is a diagram illustrating an operation example according to the second embodiment.

As illustrated in FIG. 11, in step S20, the direct link (PC5) is established between the first remote UE 100-11 and the second remote UE 100-12.

In step S21, the first remote UE 100-11 transmits an RRCReconfigurationSidelink message to the relay UE 100-2. The message may be a multi-link split bearer establishment request message (or a first multi-link split bearer establishment request message). The message includes identification information (UEID) of the second remote UE 100-12 which is the destination UE for the “U2U multi-link split bearer”. The message includes identification information of a sidelink data bearer (SL-DRB). The SL-DRB is a DRB for which the U2U multi-link split bearer is to be configured as in the first embodiment.

In step S22, the relay UE 100-2 transmits the RRCReconfigurationSidelink message to the second remote UE 100-12. The message may be a multi-link split bearer establishment request message (or a second multi-link split bearer establishment request message). The message also includes the identification information (UEID, L2 ID, or L2 Destination ID) of the second remote UE 100-12. The message also includes the identification information of the SL-DRB received from the first remote UE 100-11.

In step S23, the second remote UE 100-12 transmits an RRCReconfigurationCompleteSidelink message to the relay UE 100-2. The message may be a multi-link split bearer establishment acknowledgement message (step S22) in response to the multi-link split bearer establishment request message. The second remote UE 100-12 can confirm that the second remote UE 100-12 is the destination UE for the “U2U multi-link split bearer” from the identification information of the second remote UE 100-12 included in the RRCReconfigurationSidelink message (step S22). The second remote UE 100-12 can establish a split bearer by means of the direct link and the indirect link (i.e., “U2U multi-link split bearer”) using the SL-DRB or the like indicated by the identification information included in the RRCReconfigurationSidelink message. The second remote UE 100-12 may determine to configure the “U2U multi-link split bearer” based on this information.

In step S24, the second remote UE 100-12 and the relay UE 100-2 establish a PC5-RRC connection. The second remote UE 100-12 may establish the PC5-RRC connection by transmitting an RRCReconfigurationSidelink message to the relay UE 100-2.

In step S25, the relay UE 100-2 transmits an RRCReconfigurationCompleteSidelink message to the first remote UE 100-11. The message may also be a multi-link split bearer establishment acknowledgement message in response to the multi-link split bearer establishment request message (step S21).

In step S26, the first remote UE 100-11 and the relay UE 100-2 establish a PC5-RRC

connection. The first remote UE 100-11 can also establish a split bearer by means of the direct link and the indirect link (i.e., “U2U multi-link split bearer”) using the SL-DRB indicated by the identification information included in the RRCReconfigurationSidelink message and transmitted.

The first remote UE 100-11 and the second remote UE 100-12 perform data transmission and reception via the direct link and/or the indirect link.

### Variation of Second Embodiment

The second embodiment has described the example in which the indirect negotiation is performed using an RRCReconfigurationSidelink message. A variation of the second embodiment describes an example in which the indirect negotiation is performed using a discovery message instead of the RRCReconfigurationSidelink message.

To be specific, a first remote user equipment (e.g., the first remote UE 100-11) having established a direct link with a second remote user equipment (e.g., second remote UE 100-12) transmits a first discovery message including first identification information of the first remote user equipment and second identification information of the second remote user equipment. Second, a relay user equipment (e.g., relay UE 100-2) transmits a second discovery message including the first identification information and the second identification information in response to receiving the first discovery message. Third, the second remote user equipment selects the relay user equipment as a suitable relay user equipment based on the second discovery message. Fourth, the second remote user equipment and the relay user equipment establish an indirect link.

This allows the second remote UE 100-12 establishing the direct link with the first remote UE 100-11 to establish the PC5-RRC connection to the relay UE 100-2 in response to receiving the second discovery message. The relay UE 100-2 can also establish the PC5-RRC connection to the first remote UE 100-11 in response to receiving the first discovery message. Accordingly, the “U2U multi-link split bearer” can be configured by means of two links of the direct link and the indirect link.

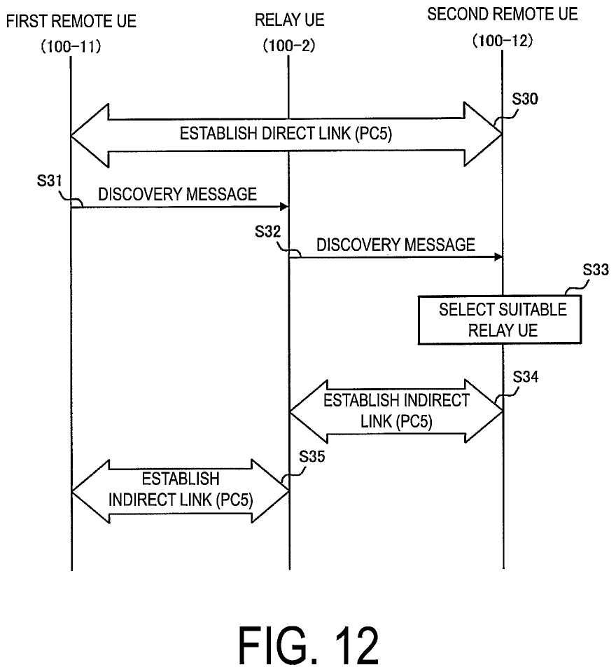

FIG. 12 is a diagram illustrating an operation example according to the variation of the second embodiment.

As illustrated in FIG. 12, in step S30, the first remote UE 100-11 and the second remote UE 100-12 establish the direct link (PC5).

In step S31, the first remote UE 100-11 transmits a discovery message (or a first discovery message). The discovery message is, for example, a message used for the relay UE 100-2 to discover another UE in proximity. The first remote UE 100-11 may periodically broadcast the discovery message. The discovery message includes the identification information (UEID, L2 ID, or L2 Destination ID) of the second remote UE 100-12 which is a destination UE for the “U2U multi-link split bearer” of the first remote UE 100-11. The discovery message further includes the identification information (UEID) of the first remote UE 100-11. The discovery message may include information indicating establishment of a multi-link split bearer (i.e., “U2U multi-link split bearer”). The discovery message may also include the SL-DRB.

In step S32, the relay UE 100-2 transmits a discovery message (or a second discovery message) in response to receiving the discovery message transmitted from the first remote UE 100-11. The discovery message includes the identification information (UEID, L2 ID, or L2 Destination ID) of the second remote UE 100-12. The discovery message further includes the identification information (UEID, L2 ID, or L2 Destination ID) of the first remote UE 100-11. The discovery message may include information indicating establishment of a multi-link split bearer (i.e., “U2U multi-link split bearer”). The discovery message may also include the SL-DRB.

Note that a relay UE other the relay UE 100-2 may also transmit a discovery message (or the second discovery message) in response to receiving the discovery message transmitted from the first remote UE 100-11. In this case, the information included in the discovery message may be the same as the identification information included in the discovery message transmitted by the relay UE 100-2.

In step S33, the second remote UE 100-12 selects a suitable relay UE (from among a plurality of relay UEs) based on the discovery message received from the relay UE 100-2 (or other relay UEs). For example, the second remote UE 100-12 may select a relay UE having the best radio quality as the suitable relay UE. Here, a description is given assuming that the relay UE 100-2 is selected as the suitable relay UE.

In step S34, the second remote UE 100-12 establishes a PC5-RRC connection to the selected relay UE 100-2. The second remote UE 100-12 may establish the PC5-RRC connection in accordance with the information indicating the establishment of the multi-link split bearer included in the discovery message received from the relay UE 100-2. The second remote UE 100-12 may establish the PC5-RRC connection by transmitting an RRCReconfigurationSidelink message to the relay UE 100-2. The second remote UE 100-12 may also request the relay UE 100-2 to establish the PC5-RRC connection to the first remote 100-11. The second remote UE 100-12 may make the request by transmitting an RRCReconfigurationSidelink message including the request to the relay UE 100-2. The second remote UE 100-12 may configure a multi-link split bearer (i.e., “U2U 100 multi-link split bearer’) for the first remote UE 100-11 based on the identification information of the first remote UE 100-11 or the identification information of the SL-DRB included in the discovery message.

In step S35, the relay UE 100-2 establishes a PC5-RRC connection to the first remote 100-11. The relay UE 100-2 may establish the PC5-RRC connection in accordance with the request for PC5-RRC connection establishment included in the RRCReconfigurationSidelink message received from the second remote 100-12.

The first remote UE 100-11 may configure the multi-link split bearer (i.e., “U2U multi-link split bearer”) for the second remote UE 100-12 based on the identification information of the second remote UE 100-12, the identification information of the SL-DRB or the like through the PC5-RRC connection.

The first remote UE 100-11 and the second remote UE 100-12 perform data transmission and reception via the direct link and/or the indirect link.

### Other Embodiments

A program may be provided that causes a computer to execute each of the processes performed by the UE 100 (including relay UE 100-2, first remote UE 100-11, and second remote UE 100-12 also) or the gNB 200. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing processing performed by the UE 100 or the gNB 200 may be integrated, and at least a part of the UE 100 or the gNB 200 may be implemented as a semiconductor integrated circuit (chipset, System on a chip (SoC)).

The phrases “based on” and “depending on” used in the present disclosure do not mean “based only on” and “only depending on,” unless specifically stated otherwise. The phrase “based on” means both “based only on” and “based at least in part on”. Similarly, the phrase “depending on” means both “only depending on” and “at least partially depending on”.

The terms “include”, “comprise” and variations thereof do not mean “include only items stated” but instead mean “may include only items stated” or “may include not only the items stated but also other items.” The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure. The embodiments, operation examples, and processing operations may be adequately combined without being inconsistent.

### Supplementary Note

Features relating to the embodiments described above are described below as supplements.
   (1)
A communication control method in a mobile communication system configured to perform a first communication on a direct link between a first remote user equipment and a second remote user equipment, and a second communication on an indirect link between the first remote user equipment and the second remote user equipment via a relay user equipment, the communication control method including,
transmitting, by the first remote user equipment having established the direct link with the second remote user equipment, a multi-link split bearer establishment request message to the second remote user equipment via the direct link, the multi-link split bearer establishment request message including identification information of the relay user equipment,
transmitting, by the second remote user equipment, a multi-link split bearer establishment acknowledgement message to the first remote user equipment via the direct link after establishing a connection to the relay user equipment, the multi-link split bearer establishment acknowledgement message including the identification information, and establishing, by the first remote user equipment, a connection to the relay user equipment.
   (2)
The communication control method according to (1) above, wherein the transmitting of the multi-link split bearer establishment request message includes transmitting, by the first remote user equipment, the multi-link split bearer establishment request message when a radio condition for the second remote user equipment deteriorates worse than a threshold.
   (3)
The communication control method according to (1) or (2) above, further including, transmitting, by the first remote user equipment, a connection complete notification message to the second remote user equipment via the direct link after establishing a connection to the relay user equipment.
   (4)
A communication control method in a mobile communication system configured to perform a first communication on a direct link between a first remote user equipment and a second remote user equipment, and a second communication on an indirect link between the first remote user equipment and the second remote user equipment via a relay user equipment, the communication control method including,
transmitting, by the first remote user equipment having established the direct link, a first multi-link split bearer establishment request message to the relay user equipment, the first multi-link split bearer establishment request message including identification information of the second remote user equipment and identification information of a sidelink data bearer, transmitting, by the relay user equipment, a second multi-link split bearer establishment request message to the second remote user equipment, the second multi-link split bearer establishment request message including the identification information of the sidelink data bearer, and
establishing, by the second remote user equipment and the relay user equipment, the indirect link.
   (5)
A communication control method in a mobile communication system configured to perform a first communication on a direct link between a first remote user equipment and a second remote user equipment, and a second communication on an indirect link between the first remote user equipment and the second remote user equipment via a relay user equipment, the communication control method including,
transmitting, by the first remote user equipment having established the direct link, a first discovery message including first identification information of the first remote user equipment and second identification information of the second remote user equipment,
transmitting, by the relay user equipment, a second discovery message including the first identification information and the second identification information in response to receiving the first discovery message,
selecting, by the second remote user equipment, the relay user equipment as a suitable relay user equipment based on the second discovery message, and
establishing, by the second remote user equipment and the relay user equipment, the indirect link.
   (6)
The communication control method according to (5) above, wherein
the establishing includes requesting, by the second remote user equipment, the relay user equipment to establish a PC5-RRC connection to the first remote user equipment, and establishing, by the relay user equipment, the PC5-RRC connection in accordance with the request.

1. A communication control method in a mobile communication system configured to perform a first communication on a direct link between a first remote user equipment and a second remote user equipment, and a second communication on an indirect link between the first remote user equipment and the second remote user equipment via a relay user equipment, the communication control method comprising:
transmitting, by the first remote user equipment having established the direct link with the second remote user equipment, a multi-link split bearer establishment request message to the second remote user equipment via the direct link, the multi-link split bearer establishment request message comprising identification information of the relay user equipment;
transmitting, by the second remote user equipment, a multi-link split bearer establishment acknowledgement message to the first remote user equipment via the direct link after establishing a connection to the relay user equipment, the multi-link split bearer establishment acknowledgement message comprising the identification information; and
establishing, by the first remote user equipment, a connection to the relay user equipment.

2. The communication control method according to claim 1, wherein
the transmitting of the multi-link split bearer establishment request message comprises transmitting, by the first remote user equipment, the multi-link split bearer establishment request message when a radio condition for the second remote user equipment deteriorates worse than a threshold.

3. The communication control method according to claim 1, further comprising:
transmitting, by the first remote user equipment, a connection complete notification message to the second remote user equipment via the direct link after establishing a connection to the relay user equipment.

4. A communication control method in a mobile communication system configured to perform a first communication on a direct link between a first remote user equipment and a second remote user equipment, and a second communication on an indirect link between the first remote user equipment and the second remote user equipment via a relay user equipment, the communication control method comprising:
transmitting, by the first remote user equipment having established the direct link, a first multi-link split bearer establishment request message to the relay user equipment, the first multi-link split bearer establishment request message comprising identification information of the second remote user equipment and identification information of a sidelink data bearer;
transmitting, by the relay user equipment, a second multi-link split bearer establishment request message to the second remote user equipment, the second multi-link split bearer establishment request message comprising the identification information of the sidelink data bearer; and
establishing, by the second remote user equipment and the relay user equipment, the indirect link.

5. A communication control method in a mobile communication system configured to perform a first communication on a direct link between a first remote user equipment and a second remote user equipment, and a second communication on an indirect link between the first remote user equipment and the second remote user equipment via a relay user equipment, the communication control method comprising:
transmitting, by the first remote user equipment having established the direct link, a first discovery message comprising first identification information of the first remote user equipment and second identification information of the second remote user equipment;
transmitting, by the relay user equipment, a second discovery message comprising the first identification information and the second identification information in response to receiving the first discovery message;
selecting, by the second remote user equipment, the relay user equipment as a suitable relay user equipment based on the second discovery message; and
establishing, by the second remote user equipment and the relay user equipment, the indirect link.

6. The communication control method according to claim 5, wherein
the establishing comprises requesting, by the second remote user equipment, the relay user equipment to establish a PC5-RRC connection to the first remote user equipment, and establishing, by the relay user equipment, the PC5-RRC connection in accordance with the request.
